(19) United States
(12) Patent Application Publication
(10) Pub. No.: US 2026/0326196 A1
(43) Pub. Date: Oct. 22, 2026

(54) Particulate feedstock compound for use in a shaping and sintering process, and shaping and sintering process

(71) Applicant: Headmade Materials GmbH, Unterpleichfeld (DE)

(72) Inventors: Christian STAUDIGEL, Unterpleichfeld (DE); Christian FISCHER, Unterpleichfeld (DE)

(21) Appl. No.: 19/104,687

(22) PCT Filed: Aug. 17, 2023
(86) PCT No.: PCT/EP2023/072671

§ 371 Date: Feb. 18, 2025

(30) Foreign Application Priority Data
Aug. 19, 2022 (WO) PCT/EP2022/073220
Aug. 19, 2022 (WO) PCT/EP2022/073223
Aug. 19, 2022 (WO) PCT/EP2022/073227
Feb. 17, 2023 (EP) 23157285.0

(51) Int. Cl. B22F 1/103; B22F 1/05; B22F 10/10; B22F 10/28; B33Y 10/00; B33Y 70/10; B33Y 80/00

(52) U.S. Cl. CPC B22F 1/103; B22F 1/05; B22F 10/10; B22F 10/28; B22F 2301/35; B22F 2304/10; B33Y 10/00; B33Y 70/10; B33Y 80/00

(57) ABSTRACT

A particulate feedstock compound for use in a shaping and sintering process comprises a) sinterable non-organic particles having a maximum particle size of 200 μm dispersed throughout the compound particle, and b) a binder component. The binder component comprises, relative to the volume of the binder component b-i) 3 to 70% by volume of a thermoplastic polyester-based polymer, and b-ii) 30 to 97% by volume of a wax or wax-type material having a drop point in the range of 20 to 160° C., wherein the polyester-based polymer has at least one of a glass transition temperature T_{G} and a crystalline melting temperature T_{P}, and, if T_{P} is present, T_{P} is 160° C. or lower, or, if T_{P} is absent, T_{G} is 160° C. or lower. Upon irradiation with an energy beam, the feedstock compound particles are converted from solid to fluid at comparably low temperature and form a dense green part without affecting adjacent feedstock compounds.

The present invention relates to a particulate feedstock compound comprising sinterable non-organic particles and a binder component, and a process comprising the steps of merging a plurality of particulate feedstock compounds, debinding and sintering. The particulate feedstock compound is useful in a powder bed additive manufacturing process.

Processes such as additive manufacturing, powder injection molding, pressing or casting allow for the generation of customized parts in a quick and efficient way. Additive manufacturing involves material being added together such as powder grains being fused together, typically layer by layer. Generally, a typical additive manufacturing process comprises the steps of forming a first material-layer, and successively adding further material-layers thereafter, wherein each new material-layer is added on a pre-formed material-layer, until the entire three-dimensional structure (3D object) is materialized.

For example, in Laser Beam Powder Bed Fusion (LB-PBF), powdered metal which is free of binder is sintered by the scanning of a high-power laser beam. To dispense with the necessity of high-power lasers, binder-coated metal powders were shaped by additive manufacturing. In a post-processing step, the binder is removed and the metal powder sintered.

Another aspect of the present invention is sustainability of sinterbased processes. Binder systems based on biopolymers and bio-sourced additives can contribute to a more sustainable and environmentally friendly powder injection molding (PIM) process.

WO 2018/197082 discloses a method for additively manufacturing a metal and/or glass-type and/or ceramic component. Feedstock compound particles are prepared from substrate particles and an at least two-phase binder. The feedstock compound particles are molten selectively in layers by means of electromagnetic radiation, such that a molded part is additively manufactured. The molded part is removed from the unmelted mixture, and the at least two-phase binder is then successively removed. Finally, the debound molded part is sintered. During a first step, one binder phase is extracted by a solvent. The residual binder, acting as a backbone to retain the shape, is removed simultaneously with and/or before the sintering process.

However, different factors during the printing process may compromise the dimensional accuracy of the part relative to the object data that defines it. For example, it is often difficult to manufacture (green) parts having sharp and accurate edges and having a low porosity. Also, improvements in the shaping step should not result in disadvantages or deteriorations in the debinding step.

It is therefore an object of the present invention to provide a particulate feedstock compound which allows for a convenient production of parts, and a simple and economical way of debinding in a in a shaping and sintering process employing the feedstock compound. In particular, when employed in an additive manufacturing processes, the particulate feedstock compound should allow for a high dimensional printing accuracy.

The invention relates to a particulate feedstock compound for use in a shaping and sintering process, comprising, based on the total volume of the particulate feedstock compound,
a) sinterable non-organic particles having a maximum particle size of 200 μm dispersed throughout the compound particle, and
b) a binder component, the binder component comprising, relative to the volume of the binder component
   b-i) 3 to 70% by volume of a thermoplastic polyester-based polymer, and
   b-ii) 30 to 97% by volume of a wax or wax-type material, having a drop point in the range of 20 to 160° C.,
wherein the polyester-based polymer has at least one of a glass transition temperature T_{G} and a crystalline melting temperature T_{P}, and,
if T_{P} is present, T_{P} is 160° C. or lower, or,
if T_{P} is absent, T_{G} is 160° C. or lower.

The invention also relates to a process comprising the steps of merging a plurality of the particulate feedstock compounds, debinding and sintering.

The following description of preferred embodiments refers to the particulate feedstock compound and the process, unless noted otherwise.

The particulate feedstock compound is useful in an additive manufacturing process such as a laser additive manufacturing process or an extrusion additive manufacturing process; an injection molding process such as a medium pressure injection molding process or a low pressure injection molding process; a pressing process; and a casting process. Preference may be given to a powder bed additive manufacturing process, in particular a sinter-based powder bed additive manufacturing process, such as a selective laser additive manufacturing process or a multi-jet fusion process.

Generally, the shaping step of additive manufacturing processes involves providing a powder bed of a particulate feedstock compound in a construction space which is usually heated to an elevated temperature, e.g. to 50 to 60° C. The particulate feedstock compound in the powder bed can absorb the energy from, e.g., an energy beam from a radiation source, such as a laser beam, and, and as a result, a localized region of the powder material increases in temperature. The local increase in temperature allows for selectively densifying or melting the particulate feedstock compound to bind the particulate feedstock compound to each other in a predefined manner.

It has been found that the melting behavior of the binder has a strong influence on the printing accuracy. While it is desirable that within the localized region a strong bond is formed between the particulate feedstock compound, formation of bonds to adjacent or neighboring particles should be avoided. Feedstock compounds with a non-optimized binder component may dissipate heat to adjacent particles which can soften and adhere to the outside surface of the part, resulting in poor surface definition.

For the binder components of the invention, the temperature transition from solid or semi-solid to fluid is very narrow, leading to less influence on adjacent feedstock compound particles in 3D printing. As a result, the feedstock compound particles irradiated with an energy beam can be converted from solid to fluid at comparably low temperature and form a dense green part without affecting adjacent feedstock compounds.

### Particulate Feedstock Compound

The particulate feedstock compound of the invention contains sinterable non-organic particles (a) and the binder component (b) as described above and is useful in a shaping and sintering process.

Herein, the term “particulate” denotes that the feedstock compound is composed of a collection (or plurality) of individual particles. The individual particles may have arbitrary shape such as irregular, cylindrical, rotational ellipsoid or essentially spherical.

Generally, the particulate feedstock compound has a particle size distribution such that at least 80% by volume, preferably at least 90% by volume, more preferably at least 95% by volume, most preferably at least 99% by volume, of the particulate feedstock compounds have a maximum particle size Bₘₐₓ in the range of 0.005 to 0.3 mm, preferably 0.008 to 0.2 mm, more preferably 0.01 to 0.2 mm, most preferably 0.015 to 0.15 mm.

Each particulate feedstock compound comprises a plurality of sinterable non-organic particles (a) dispersed throughout the particulate feedstock compound within a matrix of the binder component (b) and is held together by the binder component (b). A plurality of sinterable non-organic particles (a) per feedstock compound particle makes it possible for the shape of the particulate feedstock compound to be independent of the shape of the sinterable non-organic particles (a). Thus, for example, substantially spherical particulate feedstock compounds can be produced without the necessity of the sinterable non-organic particles (a) being spherical. This reduces the production costs since sinterable non-organic particles (a) with arbitrary or irregular particle geometry or broader particle size distribution are more readily available than powders having a particular, e.g., spherical, particle geometry.

The particulate feedstock compounds are, for example, produced by subjecting a suspension of sinterable non-organic particles (a) and a solvent, e.g. an alcoholic solvent, in which the binder component (b) was dissolved, to spray drying. Alternatively, a solidified melt of the binder component (b) having dispersed therein the sinterable non-organic particles (a) may be milled. Larger particulate feedstock compounds may also be compounded by an extruder with subsequent granulation.

In an embodiment, the particulate feedstock compound contains the sinterable non-organic particles (a) in an amount of about 0.70 to 0.99·φᵣ by volume, preferably about 0.75 to 0.98·φᵣ by volume, more preferably about 0.80 to 0.96·φᵣ Or by volume, most preferably about 0.82 to 0.95·φᵣ by volume, in particular about 0.84 to 0.94·φᵣ by volume, in particular about 0.86 to 0.93·φᵣ by volume, wherein φᵣ is the critical solids loading by volume. The remainder is comprised of binder component b).

Generally, the term “critical solids loading” is referred to as the amount of sinterable non-organic particles by volume in a feedstock compound at a critical limit. Said “critical limit” is reached when the feedstock compound becomes stiff and does not flow due to the relative viscosity becoming infinite upon addition of sinterable non-organic particles to the feedstock compound. Physically, “critical solids loading” defines the maximum packing arrangement of particles while still retaining a continuous material and it is the limit above which it is not possible to continue loading the binder matrix with solid powders. In this context, the term “relative viscosity” denotes the viscosity of the feedstock compound in relation to the viscosity of the neat binder in order to isolate the effect of the sinterable non-organic particles. The viscosity of the feedstock compound increases upon addition of sinterable non-organic particles.

There are several ways to determine the critical solids loading. For example, one can determine the peak in the torque of a kneader when more and more metal powder is added to the binder. After critical solids loading is reached, the torque usually decreases again as the feedstock compound becomes more friable. Alternatively, a pycnometer measurement may be used: up to the critical solids loading, the theoretical density is in agreement with the measured density at the pycnometer, above the critical solids loading, the measured density is below the theoretical density due to pores (see also: 1990, R. M. German, Powder Injection Molding, Metal Powder Industries Federation 1990, p. 129-130). Rheological measurements may also be used to estimate the value of the critical solids loading by plotting φ·ηᵣ:(ηᵣ−1) versus φ (J. S. Chong, E. B. Christiansen, A. D. Baer, J. Appl. Polym. Sci. 1971, 15, 2007-2021). In this context, φ denotes the loading, nr denotes the relative viscosity.

Alternatively, in an embodiment, the particulate feedstock compound contains the sinterable non-organic particles (a) in an amount of about 20 to 90% by volume, preferably 30 to 80% by volume, more preferably 40 to 75% by volume, most preferably 45 to 70% by volume, in particular 50 to 65% by volume, and the binder component (b) in an amount of about 10 to 80% by volume, preferably 20 to 70% by volume, more preferably 25 to 60% by volume, most preferably 30 to 55% by volume, in particular 35 to 50% by volume.

### Sinterable Non-Organic Particles

The sinterable non-organic particles (a) include conventionally known sinterable materials. In general, the sinterable non-organic particles (a) are selected from metals, alloys, vitreous particles and ceramic particles.

In an embodiment, metals are selected from iron, stainless steel, steel, copper, bronze, aluminum, tungsten, molybdenum, silver, gold, platinum, titanium, nickel, cobalt, chromium, zinc, niobium, tantalum, yttrium, silicon, magnesium, calcium and combinations thereof. Suitably, the metal particles have a particle size distribution such that at least 85%, preferably at least 90%, more preferably at least 95%, most preferably at least 99% of the particles have a maximum particle size Aₘₐₓ in the range of 500 nm to 400 μm, preferably 1 μm to 150 μm, more preferably 3 μm to 50 μm, most preferably 5 μm to 25 μm.

Suitably, alloys are selected from steels such as stainless steels (316 L, 17-4 PH), chromium-nickel steels, bronzes, copper alloys such as Hovadur, nickel-base alloys such as Hastelloy or Inconel, cobalt and cobalt-chromium alloys such as stellite, aluminum alloys such as Aluminum 6061, tungsten heavy alloys, titanium alloys such as grade 1 via grade 5 (Ti-6Al-4V) to grade 38 according to ASTM.

In an embodiment, ceramic particles are selected from oxides such as aluminum oxides, silicon oxides, zirconium oxides, titanium oxides, magnesium oxides, yttrium oxides; carbides such as silicon carbides, tungsten carbides; nitrides such as boron nitrides, silicon nitrides, aluminum nitrides; silicates such as steatite, cordierite, mullite; and combinations thereof. Suitably, the ceramic particles have a particle size distribution such that at least 85%, preferably at least 90%, more preferably at least 95%, most preferably at least 99% of the particles have a maximum particle size Aₘₐₓ in the range of 200 nm to 25 μm, preferably 300 nm to 10 μm, more preferably 400 nm to 7 μm, most preferably 500 nm to 3 μm.

In an embodiment, vitreous particles are selected from non-oxide glasses such as halogenide glasses, chalcogenide glasses; oxide glasses such as phosphate glasses, borate glasses, silicate glasses such as aluminosilicate glasses, lead silicate glasses, boron silicate glasses, soda lime silicate glasses, quartz glasses, alkaline silicate glasses; and combinations thereof. Suitably, the vitreous particles have a particle size distribution such that at least 85%, preferably at least 90%, more preferably at least 95%, most preferably at least 99% of the particles have a maximum particle size Aₘₐₓ in the range of 200 nm to 25 μm, preferably 300 nm to 10 μm, more preferably 400 nm to 7 μm, most preferably 500 nm to 3 μm.

Suitably, the average particle size and all other parameters that are useful to describe the particle size, shape and distribution of the powder according to the invention are determined by optical methods, preferably by dynamic picture analysis according to ISO 13322-2. In this regard, the average particle size preferably corresponds to the value Mv (also referred to as “mean diameter” and “Mv3(x)”, respectively). ISO 13322-2:2006 describes methods for controlling the position of moving particles in a liquid or gas, as well as the image capture and image analysis of the particles. These methods are used to measure the particle sizes and their distributions, the particles being appropriately dispersed in the liquid or gas medium. A suitable device is the particle size analyzer Camsizer X2 device (available from Retsch Technology GmbH; Haan; Germany) using air as a carrier.

Suitably, the sinterable non-organic particles (a) may contain combinations of more than one of metals, alloys, vitreous particles and ceramic particles as described above, for example hard metals or metal matrix composites (also referred to as metal ceramic composites).

### Thermoplastic Polyester-Based Polymer

The binder component (b) comprises 3 to 70% by volume, preferably 5 to 60% by volume, more preferably 7 to 50% by volume, most preferably 10 to 40% by volume, in particular 12 to 35% by volume, in particular 15 to 30% by volume, of a thermoplastic polyester-based polymer (b-i), based on the total volume of the binder component (b).

The expression “polyester-based polymer” is intended to encompass polymers with recurring ester linkages in the polymeric backbone (as opposed to ester linkages in a side-chain of the polymer). Besides ester-linkages, the polymeric backbone can comprise other linkages such as ether linkages, amide linkages, and/or urethane linkages, preferably ether linkages, and/or amide linkages. The linkages other than ester linkages may be distributed in a random or block-wise fashion in the polymer. Polyester-based polymers incorporating linkages other than ester linkages in addition to ester linkages include polyester-ethers, polyether-esters, and polyesteramides.

As polyester-based polymers can potentially be sourced from living organisms or synthesized from renewable sources, binder components incorporating such bio-based polyesters can contribute to a more sustainable and environmentally friendly shaping and sintering process.

Polyester-based polymers include the various types of polyesters and copolyesters characterized by the presence of ester functions (—COO—) along the chain. They can be obtained by condensation type polymerization of hydroxyacids, lactons, and the joint condensation type polymerization of diols and diacids.

Linear polyesters can be classified into three classes of aliphatic, partly aromatic and aromatic polymers. Aliphatic polyesters are obtained from aliphatic dicarboxylic acids (or esters) and aliphatic diols. Partly aromatic polyesters are obtained from aromatic dicarboxylic acids (or esters) and aliphatic diols. Aromatic polyesters have all ester functions attached to aromatic rings. By using different difunctional reactants, copolyesters can be obtained. By using at least partially multifunctional, i.e. more than difunctional, reactants, branched polyesters can be obtained.

Copolyesters comprise at least two distinct types of repeating units. The comonomers are selected such that the polyester-based copolymers meets one or more certain melting criteria, including, e.g., DSC melting temperature T_{P}; melt viscosity and melt volume-flow rate. Copolyesters of more than one acid and/or one or more diols may be preferred to achieve a balance of properties such as melting point, flexibility, rate of crystallization, etc. Introduction of an additional monomer, for example, sebacic acid or azelaic acid in butylene terephthalate/iosphthalate polymers, results in further modification of the properties. In general, introduction of the aliphatic chains results in lowering of the melting point, increased flexibility, greater adhesion properties, and in the case of crystalline polyesters, a faster crystallization rate.

Generally, polyesteramides are polyesters with additional amide linkage in the “backbone” of the polymer chain and for example can be synthesized by using &-caprolactame, adipic acid and 1,4-butanediol.

Both crystalline or partly crystalline, or amorphous polyester-based polymers may be used for implementing the invention. Crystalline or partly crystalline polyester-based polymers are characterized by having a crystalline melt peak. Amorphous polyester-based polymers which do not exhibit a crystalline melt peak are characterized by their glass transition temperature T_{G}. Crystalline or partly crystalline polyester-based polymers are preferred.

The thermoplastic polyester-based polymer is characterized by having at least one of a glass transition temperature T_{G} and a crystalline melting temperature T_{P}, and if T_{P} is present, T_{P} is 160° C. or lower, or, if T_{P} is absent, T_{G} is 160° C. or lower. Preferably, if T_{P} is present, T_{P} is 150° C. or lower, more preferably 140° C. or lower, most preferably 130° C. or lower, in particular 120° C. or lower, or, if T_{P} is absent, T_{G} is 150° C. or lower, more preferably 140° C. or lower, most preferably 130° C. or lower, in particular 120° C. or lower. Generally, if T_{P} is present, T_{P} is 30° C. or higher, more preferably 40° C. higher, or, if T_{P} is absent, T_{G} is 30° C. or higher, more preferably 40° C. or higher.

T_{P} or T_{G} within the identified range allow for selective densifying or melting with as little additional energy (e.g. laser energy) as possible, and low energy laser sources can conveniently be used.

Differential scanning calorimetry (DSC) allows for the determination of physical properties of a material, including the glass transition temperature T_{G}, and crystalline melting temperature T_{P}, melting enthalpy etc.

For crystalline polymers, the melting process results in an endothermic peak in the DSC curve and the melting temperature refers to the crystalline melting temperature T_{P} in said DSC curve where the rate of change of endothermic heat flow is maximum (also referred to as “melt peak temperature”).

The DSC curve may comprise a single melt peak. Alternatively, the DSC curve may comprise several melt peaks, i.e. several local maxima. For the purposes herein, the crystalline melting temperature T_{P} is defined as the temperature at the global maximum.

The glass transition T_{G} can be observed by a step in the baseline of the measurement curve. It is characterized by its onset, midpoint, inflection and endset temperature. For the purpose herein, the T_{G} is the inflection temperature.

Herein, the measurement is determined in accordance with DIN EN ISO 11357 in the second heating after a first heating/cooling cycle. For this purpose, a sample is heated in a first heat ramp from −20° C. to a temperature which is 20 K above completion of all thermal events, cooled to −20° C. afterwards and finally heated again in a second heat ramp from −20° C. to the temperature which is 20 K above completion of all thermal events, each with a heating and cooling rate of 10 K/min. “Thermal events” for the purpose herein means thermal events other than decomposition, or in other words, essentially reversible thermal events.

Preferably, the thermoplastic polyester-based polymer has a melt viscosity below 1500 Pa·s, preferably below 1300 Pa·s, more preferably below 1000 Pa·s, most preferably below 800 Pa·s, in particular below 600 Pa·s, in particular below 500 Pa·s, in particular below 400 Pa·s, in particular below 300 Pa·s, in particular below 200 Pa·s, in particular below 100 Pa·s, according to ISO 1133 with 2.16 kg at 160° C.

Preferably, the thermoplastic polyester-based polymer has a melt viscosity below 1500 Pa·s, preferably below 1300 Pa·s, more preferably below 1000 Pa·s, most preferably below 800 Pa·s, in particular below 600 Pa·s, in particular below 500 Pa·s, in particular below 400 Pa·s, in particular below 300 Pa·s, in particular below 200 Pa·s, in particular below 100 Pa·s, according to ISO 1133 with 2.16 kg at 190° C.

Preferably, the thermoplastic polyester-based polymer has a melt volume-flow rate of at least 1 cm³/10 min, preferably at least 2 cm³/10 min, more preferably at least 3 cm³/10 min, most preferably at least 4 cm³/10 min, in particular at least 5 cm³/10 min, in particular at least 6 cm³/10 min, in particular at least 7 cm³/10 min, in particular at least 8 cm³/10 min, in particular at least 9 cm³/10 min, in particular at least 10 cm³/10 min, in particular at least 20 cm³/10 min, in particular at least 30 cm³/10 min, in particular at least 40 cm³/10 min, in particular at least 50 cm³/10 min, in particular at least 60 cm³/10 min, in particular at least 70 cm³/10 min, in particular at least 80 cm³/10 min, in particular at least 90 cm³/10 min, in particular at least 100 cm³/10 min, in particular at least 110 cm³/10 min, in particular at least 120 cm³/10 min, in particular at least 130 cm³/10 min, in particular at least 140 cm³/10 min, in particular at least 150 cm³/10 min, in particular at least 160 cm³/10 min, in particular at least 170 cm³/10 min, in particular at least 180 cm³/10 min, in particular at least 190 cm³/10 min, in particular at least 200 cm³/10 min, according to ISO 1133 with 2.16 kg at 160° C.

Preferably, the thermoplastic polyester-based polymer has a melt volume-flow rate of at least 1 cm³/10 min, preferably at least 2 cm³/10 min, more preferably at least 3 cm³/10 min, most preferably at least 4 cm³/10 min, in particular at least 5 cm³/10 min, in particular at least 6 cm³/10 min, in particular at least 7 cm³/10 min, in particular at least 8 cm³/10 min, in particular at least 9 cm³/10 min, in particular at least 10 cm³/10 min, in particular at least 20 cm³/10 min, in particular at least 30 cm³/10 min, in particular at least 40 cm³/10 min, in particular at least 50 cm³/10 min, in particular at least 60 cm³/10 min, in particular at least 70 cm³/10 min, in particular at least 80 cm³/10 min, in particular at least 90 cm³/10 min, in particular at least 100 cm³/10 min, in particular at least 110 cm³/10 min, in particular at least 120 cm³/10 min, in particular at least 130 cm³/10 min, in particular at least 140 cm³/10 min, in particular at least 150 cm³/10 min, in particular at least 160 cm³/10 min, in particular at least 170 cm³/10 min, in particular at least 180 cm³/10 min, in particular at least 190 cm³/10 min, in particular at least 200 cm³/10 min, according to ISO 1133 with 2.16 kg and 190° C.

In an embodiment, the thermoplastic polyester-based polymer (b-i) is semi-crystalline. The term “semi-crystalline” characterizes those polymers which possess high degrees of inter- and intra-molecular order. The semi-crystalline nature of a polymer can be verified by a first order transition or crystalline melting point (T_{P}) as determined by differential scanning calorimetry (DSC). Preferably, the thermoplastic polyester-based polymer (b-i) is semi-crystalline because it exhibits a sharp transition separating the fluid and solidified states. Further, it is characterized by a strength increase by crystallization upon solidification.

Suitable polyester-based polymers include polyester-based polymers such as polycaprolactone, polylactides, polyglycolides, poly(butylene succinate), poly(hydroxyl alkanoates) such as poly(3-hydroxy butyrate), poly(3-hydroxy valerate), poly(hydroxybutyrat-co-hydroxyvalerat) ENMAT Y1000P (available from TianAn Biologic Materials Co., Ltd.), joint condensation type polymerization products of diols and diacids, such as phthalates such as polyethylene terephthalate (PET), polytrimethylene terephthalate (PTT), polybutylene terephthalate (PBT), polycarbonates, copolyesters such as Abifor 606, Griltex 6E, Griltex 8E, Griltex 9E, Griltex D 1365E, Griltex D 1442E, Griltex D 1539E, Griltex D 1655E, Griltex D 1841E, Griltex D 1682E, Griltex D 1939E, Griltex D 2132E, Griltex D 2245E, Riteflex 425.

Abifor 606 (available from abifor adhesive technology), polycaprolactone, Riteflex 425 (available from Celanese GmbH) is a particularly preferred thermoplastic polyester-based polymer.

### Wax or Wax-type Material

The binder component (b) further comprises 30 to 97% by volume, preferably 40 to 95% by volume, more preferably 50 to 93% by volume, most preferably 60 to 90% by volume, in particular 65 to 88% by volume, in particular 70 to 85% by volume, of the wax or wax-type material (b-ii), based on the total volume of the binder component (b).

The wax or wax-type material is characterized by having a drop point in the range of from 20 to 160° C. according to DIN ISO 2176. More preferably, the wax has a drop point in the range of from 30 to 150° C., still more preferred in the range of from 35 to 140° C., in particular in the range of from 40 to 130° C., in particular in the range of from 40 to 120° C., in particular in the range of from 40 to 110° C., in particular in the range of from 40 to 100° C., and most preferred in the range of from 40 to 90° C.

The drop point within the identified range, together with T_{P} or T_{G} of the thermoplastic polyester-based polymer ensures a favorable overall melting behavior of the binder.

More preferably, the wax has a melt viscosity below 30 Pa·s, preferably below 20 Pa·s, more preferably below 10 Pa·s, most preferably below 5 Pa·s, in particular below 3 Pa·s, in particular below 1 Pa·s, in particular below 700 mPa·s, in particular below 300 Pa·s, in particular below 100 mPa·s, in particular below 50 mPa·s, according to DIN EN ISO 3104 at 160° C.

More preferably, the wax has a melt viscosity below 40 Pa·s, preferably below 30 Pa·s, more preferably below 20 Pa·s, most preferably below 10 Pa·s, in particular below 5 Pa·s, in particular below 3 Pa·s, in particular below 1 Pa·s, in particular below 700 mPa·s, in particular below 300 Pa·s, in particular below 100 mPa·s, according to DIN EN ISO 3104 at 120° C.

The term “wax” is a collective technological term for a group of organic substances that can generally be described in terms of their physical and technical properties. In particular, waxes are characterized by the fact that they are solids with a melting point above ambient temperature (usually between 50° C. and 160° C.), a low melt viscosity (below 10 Pa·s at 10° C. above the melting point). Waxes melt without decomposing. Waxes can also be divided in natural waxes of fossil origin such as paraffin, montan wax; natural waxes of natural origin such as beeswax, carnauba wax; semi-synthetic waxes (also referred to as chemically modified natural waxes) such as ethylene-bis-stearamide; and synthetic waxes such as polyolefin waxes. In the context of this patent application, the expression “wax-type materials” is intended to include waxes as well as wax-type substances such as ester-type waxes, higher or polyhydric alcohols, higher fatty acids showing wax-like properties, and mixtures thereof.

Suitable wax-type materials include:
paraffin waxes such as microcrystalline wax;
ester-type waxes such as beeswax, candelilla wax, carnauba wax,
esters of organic acids such as sulfonic acids or carboxylic acids, preferably of fatty acids having 6 to 40 carbon atoms or esters of aromatic carboxylic acids such as benzoic acid, phthalic acid or hydroxybenzoic acid;
amide waxes such as amides of organic acids such as sulfonic acids or carboxylic acids, preferably of fatty acids having 6 to 40 carbon atoms such as oleamide such as Deurex A 27 P (available from Deurex AG), erucamide such as Deurex A 26 P (available from Deurex AG), ethylene-bis-stearamide such as Deurex A 20 K (available from Deurex AG); sulfonamide such as N-ethyltoluene-4-sulfonamide;
polyolefinic waxes such as
polyethylene-wax such as Deurex E 06 K, Deurex E 08, Deurex E 09 K, Deurex E 10 K (available from Deurex AG), VISCOWAX® 111, VISCOWAX® 116, VISCOWAX® 123, VISCOWAX® 135 (available from Innospec Leuna);
oxidized polyethylene wax such as Deurex EO 40 K, Deurex EO 42, Deurex EO 44 P, Deurex E 76 K (available from Deurex AG), VISCOWAX® 252, VISCOWAX® 262, VISCOWAX® 271, VISCOWAX® 2628 (available from Innospec Leuna),
copolymeric waxes of polyolefins, preferably ethylene vinyl acetate such as VISCOWAX® 334, VISCOWAX® 453 (available from Innospec Leuna),
polypropylene-wax such as Deurex P 36 K, Deurex P 37 K (available from Deurex AG),
oxidized polypropylene wax;
Fischer-Tropsch wax such as VESTOWAX EH 100, VESTOWAX H 2050 MG, VESTOWAX SH 105, Shell GTL Sarawax SX 105, Shell GTL Sarawax SX 80 (available from Evonik Industries AG);
higher organic acids such as fatty acids having 10 to 40 carbon atoms;
higher or polyhydric alcohols such alcohols having 10 to 40 carbon atoms;
polyethylene glycol;
and mixtures thereof.

In order to accommodate different purposes, the wax or wax-type material may be a mixture of different waxes or wax-type materials.

Generally, paraffin waxes such as microcrystalline wax are derived from petroleum. For example, microcrystalline wax is obtained as a refined mixture of solids mainly containing saturated aliphatic hydrocarbons produced by de-oiling of certain fractions from the petroleum refining process.

Generally, the ester-type waxes may be waxes occurring naturally or produced synthetically. Suitably, naturally occurring ester-type waxes are selected from beeswax, candelilla wax, and carnauba wax; and synthetically produced ester-type waxes are suitably selected from esters of carboxylic acids, preferably of fatty acids having 5 to 34 carbon atoms, more preferably of fatty acids having 10 to 28 carbon atoms, or esters of a hydroxybenzoic acid. Preferably, the ester-type waxes comprise the esters of a hydroxybenzoic acid such as esters of 4-hydroxybenzoic acid. Loxiol 2472 (4-hydroxybenzoic behenylester, available from Emery Oleochemicals GmbH) is particularly preferred.

Generally, polyolefin waxes can be produced by thermally decomposing branched high molecular weight polyolefins or directly polymerizing olefins. Suitable polyolefin waxes include, for example, homopolymers of propylene or higher 1-olefins, copolymers of propylene with ethylene or with higher 1-olefins or their copolymers with one another. The higher 1-olefins are preferably linear or branched olefins having 4 to 20, preferably 4 to 6 carbon atoms. These olefins may have an aromatic substitution conjugated to the olefinic double bond. Examples of these are 1-butene, 1-hexene, 1-octene or 1-octadecene, and styrene. The polyolefin waxes may be oxidized. Polyethylene waxes such as Deurex E 06 K (available from Deurex AG) are particularly preferred.

Generally, amide waxes such as amides of sulfonic acids or carboxylic acids, preferably fatty acids can be produced by condensation reactions of amides such as ethylenediamine and sulfonic acids or carboxylic acids, preferably fatty acids having 5 to 34 carbon atoms, preferably 10 to 28 carbon atoms. Oleamide such as Deurex A 27 P (available from Deurex AG), erucamide such as Deurex A 26 P (available from Deurex AG), ethylene-bis-stearamide such as Deurex A 20 K (available from Deurex AG) are particularly preferred.

In view of a compromise between compatibility with the thermoplastic polyamide and solvent solubility, the wax or wax-type material is preferably selected from polar waxes and polar wax-type materials.

Herein, the term “polar wax” or “polar wax-type material” means a wax or wax-type material whose chemical structure is formed essentially from, or even constituted by, carbon and hydrogen atoms, and comprising at least one highly electronegative heteroatom such as an oxygen, nitrogen or sulfur atom.

Preferably, the polar wax is selected from oxidized polyolefinic waxes, ester-type waxes, amide waxes, higher organic acids, higher or polyhydric alcohols, polyethylene glycol, and mixtures thereof.

Preferably, the ester-type waxes include esters of organic acids. Preferably, the amide waxes include amides of organic acids such as sulfonic acids or carboxylic acids. Representatives of suitable waxes that are commercially available are those mentioned above.

In a still more preferred embodiment, b-ii) is a wax-type material selected from aromatic esters and aromatic sulfonamides. The alcohol of the aromatic ester may be an alcohol having 1 to 40 carbon atoms. The aromatic sulfonamides may carry at least one organic moiety having 1 to 40 carbon atoms at the amide nitrogen atom.

### Plasticizer

In an embodiment, the binder component b-ii) is a plasticized wax or wax-type material. “Plasticized wax or wax-type material” means the combination of a wax or wax-type material with a plasticizer. Generally, a plasticizer is a high-boiling liquid with a boiling point generally above 180° C. which is compatible with the wax or wax-type material to decrease its melt viscosity. The skilled person will appreciate that the ternary combination of the thermoplastic polyester-based polymer, the wax or wax-type material, and the plasticizer forms a homogeneous phase. Generally, plasticizers are polar compounds which means that their chemical structure comprises at least one highly electronegative heteroatom such as an oxygen atom or a nitrogen atom.

Suitably, the plasticized wax or wax-type material b-ii) comprises the plasticizer in an amount of up to 50 vol.-%, preferably up to 40 vol.-%, more preferably up to 30 vol.-%, most preferably up to 20 vol.-%, in particular up to 15 vol.-%, in particular up to 10 vol.-%, relative to the total volume of b-ii).

### Suitable Plasticizers Include

liquid esters of aliphatic carboxylic acids such as dimethyl sebacate, di-n-octyl sebacate, dimethyl succinate, dimethyl adipate, dibutyl adipate, dioctyl adipate, dimethyl azelate, dioctyl azelate, di-n-butyl maleic ester, dioctyl maleate, butyl oleate, dimethyl hexanedioate, benzyl laurate, methyl laurate, ethyl myristate, diacetyl triethyl citrate, acetyl tributyl citrate;
liquid esters of aromatic carboxylic acids such as dimethyl phthalate, methyl 2-hydroxybenzoate, butyl 4-hydroxybenzoate, butyl benzoate, 2-ethylhexyl benzoate, bis(2-ethylhexyl) terephthalate;
alkylsulfonic phenyl ester;
liquid amides such as n-butylbenzenesulfonamide, N-ethyltoluene-2-sulfonamide, N-ethyl-4-toluenesulfonamide;
liquid organic acids such as carboxylic acids such as fatty acids such as caprylic acid, myristoleic acid;
higher alcohols such as 1-decanol, 2-decanol, 1-octadecanol;
polyhydric alcohols such as butanediol, ethylene glycol, propylene glycol;
and mixtures thereof.

Plasticizers selected from aromatic esters and aromatic sulfonamides are generally preferred.

### Optional Binder Components

The binder component (b) comprises at least two binder component ingredients: the thermoplastic polyester-based polymer (b-i) and the wax or wax-type material (b-ii). Optionally, the binder component (b) may comprise further functional additives in view of good processability.

The binder component (b) may comprise a dispersant. One material constituting, for example, the wax or wax-type material (b-ii) may act as a dispersant. Otherwise, an extraneous dispersant may additionally be incorporated.

Generally, the dispersant acts as an adhesion promotor and/or compatibilizer between the binder components (b-i) and/or (b-ii); and/or between the non-organic particles (a) and the binder component (b).

Suitably, the dispersant is selected from fatty acids having 10 to 24 carbon atoms such as capric acid, lauric acid, myristic acid, palmitic acid, stearic acid, arachidic acid, behenic acid, lignoceric acid, or oleic acid, preferably stearic acid.

Suitably, the extraneous dispersant is selected from metal salts of fatty acids. Generally, the metal may be selected from alkali metals, alkaline earth metals or transition metals such as lithium, sodium, potassium, magnesium, calcium, strontium, barium, and zinc. Suitably, the fatty acid may be selected from the fatty acids having 5 to 34 carbon atoms, preferably 10 to 28 carbon atoms as described above. Preferred metal salts of fatty acids are selected from sodium stearate, magnesium stearate, zinc stearate or magnesium oleate.

Due to the viscosity of the binder component (b) in the abovementioned ranges, the latter becomes, in the molten state, uniformly and homogeneously distributed between the sinterable non-organic particles (a) and joins the individual sinterable non-organic particles (a) or the individual particulate feedstock compounds.

In order to adjust the viscosity of the binder component (b), it may be desirable to incorporate a thinning agent or thickening agent. Thickening agents serve to increase the viscosity of the binder component when molten. This enhanced viscosity prevents the sag of the sinterable non-organic particles and facilitates uniform flow of the particles and imparts resistance to segregation and sedimentation. Thinning agents are employed to lower the viscosity of the overall binder component. The thinning agent can act as a plasticizer to allow control of the rheological properties and the fluidity of the thermoplastic polyester-based polymer (b-i) or the wax or wax-type material (b-ii).

Suitably, the thickening or thinning agent is selected from waxes and/or thermoplastic polymers such as polyolefins and polyolefin waxes, polyamides and amide waxes, paraffin waxes, ester-based polymers and ester-type waxes; vinyl esters such as ethylene vinyl acetate; abietates; adipates; alkyl sulfonates; amines and amides such as formamide, hydroxylalkylformamide, amine, diamine; azelates; benzoates; citrates; chlorinated paraffins; ether-ester plasticizers; glutarates; hydrocarbon oils; isobutyrates; maleates; oleates; phosphates; phthalates; sulfonamides; oily liquids such as peanut oil, fish oil, castor oil; and mixtures thereof. Suitably, polyethylene wax Deurex E 09 K having a viscosity of <40 mPa·s at 140° C. can be used as a thinning agent, while Deurex E 25 having a viscosity of 4000 mPa·s at 140° C. or even higher molecular weight polyolefinic compounds can be used as thickening agent.

In an embodiment, the thickening or thinning agent and/or dispersant may be present in an amount of 0 to 15% by volume, preferably 0.01 to 10% by volume, more preferably 0.02 to 8% by volume, most preferably 0.5 to 6% by volume, based on the total volume of the binder component (b).

In an embodiment, b-i) and b-ii) constitute to at least 60% by volume, preferably at least 70% by volume, more preferably at least 80% by volume, in particular at least 85% by volume, of the binder component.

### Solvent Debinding

The thermoplastic polyester-based polymer (b-i) and the wax or wax-type material (b-ii) differ in their solubility in a solvent. The solvent is preferably selected from alcohols such as ethanol, propanol or hexanol; aromatic compounds such as benzene, toluene, or xylene; esters such as ethyl acetate; ethers such as diethylether, or tetrahydrofuran; ketones such as acetone; alkanes such as hexane, or heptane; halogenated hydrocarbons such as n-propyl bromide, trichloroethylene, perchloroethylene, n-methyl pyrrolidine; and mixtures thereof; water; and gases in supercritical state.

Different solubility allows for selective debinding. In the selective debinding step, one binder component is removed wherein at the same time another binder component remains within the part to be manufactured, holding together the sinterable non-organic particles. Such debinding processes, e.g. solvent debinding, are known per se.

Suitably, in the solvent debinding process, one binder component may be selectively removed from a green part by means of dissolving said binder component in a solvent, wherein a second binder component remains within the green part. Therefore, the binder components need to differ in e.g. molecular weight or polarity in order to exhibit different solubilities in the solvent.

### Process

The invention further relates to a process comprising the steps of:
merging a plurality of the particulate feedstock compounds to obtain a green part, and
partially debinding the green part by selectively removing the wax or wax-type material (b-ii) to obtain a brown part comprising the sinterable non-organic particles (a) bound to each other by the thermoplastic polyester-based polymer (b-i), and
sintering the brown part to obtain a sintered part.

In an embodiment, the process is selected from an additive manufacturing process such as a laser additive manufacturing process or an extrusion additive manufacturing process; an injection molding process such as a medium pressure injection molding process or a low pressure injection molding process; a pressing process; and a casting process.

In a preferred embodiment, the process is selected from a powder bed additive manufacturing process, in particular a sinter-based powder bed additive manufacturing process, such as a selective laser additive manufacturing process or a multi-jet fusion process.

In the context of the present patent application, the term “merging” refers to “selectively melting and solidifying” in the event that the process is selected from an additive manufacturing process using radiation; or the term “merging” refers to “melting and solidifying” in the event that the process is selected from an injection molding process or a casting process or a pellet printing process; or the term “merging” refers to “compacting” or “compacting, partly or fully melting and solidifying” in the event that the process is selected from a pressing process.

By carefully selecting the components and process parameters, components may be obtained which preferably do not have any cracking. Such cracking occurs, e.g., when debinding is carried out too fast or at harsh conditions. Thus, the components and process parameters are preferably selected such that harmful conditions are avoided.

Generally, in an additive manufacturing process using radiation from a laser-array, radiation heating element etc., e.g. a laser additive manufacturing process or a multi jet fusion process from HP Inc., the particulate feedstock compounds are applied layer-wise followed by densification and solidifying, e.g. by cooling. During the densification, the binder component (b) which is comprised in the particulate feedstock compounds is selectively and layer-wise molten by means of electromagnetic radiation, e.g. of a laser.

In a preferred embodiment, the step of merging a plurality of the particulate feedstock compounds comprises the steps of:
providing a first layer of feedstock compound particles;
selectively densifying the first layer of feedstock compound particles to bind the compound particles to each other in a predefined manner so to produce a first shaped part layer;
providing at least one further layer of feedstock compound particles on the first shaped part layer; and
selectively densifying the further layer feedstock compound particles to bind the feedstock compound particles to each other in a predefined manner so to produce at least one further shaped part layer, the first shaped part layer and the further shaped part layers forming a green part.

Preferably, selectively densifying the first and further layer of compound particles involves selectively irradiating at least one of the first or the at least one further layer with electromagnetic radiation, preferably a laser beam.

Generally, an extrusion additive manufacturing process is a process in which a feedstock compound is fed as granule, is melted in a heated printer extruder head, and is deposited layer-wise to build up a green part. The print head is moved under computer control to define the printed shape. Usually, the head moves in two dimensions to deposit one horizontal plane, or layer, at a time; the work or the print head is then moved vertically by a small amount to begin a new layer. After the printing process, the shaped feedstock compound can be removed as a solidified green part. The green part comprises the sinterable non-organic powder particles and the binder.

Generally, an injection molding process such as a medium pressure injection molding process or a low pressure injection molding process, is a process in which a finely-powdered feedstock material is mixed with a binder to create a feedstock compound which is then molten and injected into a mold in a liquid state (shaping). After cooling, the shaped feedstock compound solidifies inside the mold and can be taken out giving a green part (molding). The green part comprises the feedstock and the binder. In the case of the finely-powdered material being a metal or an alloy, the process is referred to as metal injection molding (MIM) process. In the case of the finely-powdered material being a ceramic, the process is referred to as a ceramic injection molding (CIM) process. In general, processes including finely-powdered material are referred to as powder injection molding (PIM) processes. Further suitable sinterable non-organic powder particles include, for example, glasses, ceramics, or polymers, or mixtures thereof.

Generally, a casting process is a process in which the feedstock compound is molten and poured into a casting mold in a liquid state (shaping). After cooling, the shaped feedstock compound solidifies inside the casting mold and can be taken out giving a green part. The green part comprises the feedstock and the binder. In an embodiment, the casting mold is a lost casting mold, i.e. the casting mold can be only used for one green part, since the casting mold e.g. has to be broken for obtaining the green part. The lost casting mold can be manufactured by different methods such as casting or additive manufacturing, e.g. by an extrusion additive manufacturing process or an inkjet additive manufacturing process. The lost form could be printed of a polymer, that is also soluble in a solvent, such as acrylonitrile-butadiene-styrene (ABS) in acetone. In an embodiment, one section of the casting form is printed, that section is at least partly filled with the feedstock compound, these steps are repeated until the printing of the casting form and filling of the casting form is finished. Preferably both, cast and green part, can be dissolved and debound in the same solvent. The green part comprises the sinterable non-organic powder particles and the binder. After the shaping by casting step, the green part undergoes conditioning operations to densify the powders (sintering).

Generally, in a pressing process, a green part may be formed from particulate feedstock compounds comprising finely-powdered feedstock and a binder by applying high pressures on a plurality of particulate feedstock compounds for densification (shaping by pressing). Suitably, the densification may be accompanied by heat, the particulate feedstock compound may be partially or fully melted. The green part comprises the sinterable non-organic powder particles and the binder. After the shaping by pressing step, the green part undergoes conditioning operations to densify the powders (sintering).

The aforementioned processes may also be combined.

A building chamber is configured to receive the particulate feedstock compound. Upon selectively densifying, for example by a laser additive manufacturing process, the feedstock compound particles are bound to each other in a predefined manner so to produce a first shaped part layer. Then, at least one further layer of feedstock compound particles is selectively densified on the first shaped part layer to bind the feedstock compound particles to each other in a predefined manner so to produce at least one further shaped part layer joined to the first shaped part layer. The first shaped part layer and the further shaped part layers jointly form an integral part. The integral part may then be removed from the building chamber and freed from unbound particulate feedstock compound. In the process, the binder component (b) becomes distributed between the sinterable non-organic particles (a) and holds them together after solidification. After the green part was made, it is taken out from the unmelted layers or the mold.

The partial removal of the temporary organic binder is preferably carried out by solvent treatment.

Suitably, the wax or wax-type material (b-ii) is selectively removed, whereas the thermoplastic polyester-based polymer (b-i) is not removed. The resulting part after the debinding step is referred to as a brown part. The brown part comprises sinterable non-organic particles (a) bound to each other by the thermoplastic polyester-based polymer (b-i) and, optionally, remaining wax or wax-type material (b-ii).

The remaining binder components retained in the brown part provide a brown part that is stable and sufficiently strong to be handled and transported between the debinding and sintering steps.

In the solvent treatment process, the green part is dipped into a suitable solvent. Suitably, the solvent is selected such that the thermoplastic polyester-based polymer (b-i) has a lower solubility than the wax or wax-type material (b-ii) in the solvent or, preferably, the thermoplastic polyester-based polymer (b-i) is essentially insoluble in the solvent and the wax or wax-type material (b-ii) is soluble in the solvent. Suitable solvents are selected from alcohols such as ethanol, propanol or hexanol; aromatic compounds such as benzene, toluene or xylenes; esters such as ethyl acetate; ethers such as diethylether or tetrahydrofuran; ketones such as acetone; alkanes such as hexane or heptane; halogenated hydrocarbons such as n-propyl bromide, trichloroethylene, perchloroethylene, n-methyl pyrrolidine; water; gases in supercritical state; and mixtures thereof. During the solvent treatment process, the solvent is preferably kept at a temperature T_{L} in the range of 20 to 100° C., preferably 25 to 80° C., more preferably 30 to 60° C.

The partial removal of the binder component (b-ii) results in a porous structure of the brown part. The sinterable non-organic particles (a) are held together by the thermoplastic polyester-based polymer (b-i).

### Sintering Step

The process further comprises the step of sintering the brown part to obtain a sintered part.

For this purpose, the brown part is suitably subjected to a sintering step after the debinding step. During the sintering step, the thermoplastic polyester-based polymer (b-i) is removed and the debound part (brown part) is sintered to obtain the sintered part. Generally, on further removal of the binder and the subsequent sintering of the brown part, shrinkage occurs.

Suitably, the residual binder is driven out at a first temperature T₁ which is in the range of 100 to 750° C., preferably 150 to 700° C., more preferably 200 to 650° C., most preferably 300 to 600° C. A suitable temperature T₁ may also be dependent on the atmosphere. Preferably, the first temperature T₁ is selected as a function of the residual binder components. The removal of the thermoplastic polyester-based polymer (b-i) at the temperature T₁ is carried out for a period of time Δt₁ which is dependent on the part geometry and in particular is proportional to the square of the wall thickness of the part to be produced. Preferably, the period of time Δt₁ is selected such that at least 95%, preferably at least 99%, more preferably at least 99.9%, most preferably 100% of the binder components (b-i) and (b-ii) are removed. Binder which is not removed is not available as polymeric binder in the part but is diffused, e.g. as carbon, into the metal part and increases the carbon content in the metal part. Thermal debinding may be carried out at more than one temperature T₁, e.g. the removal of a part of the thermoplastic polyester-based polymer (b-i) at the temperature T₁ₐ is carried out for a period of time Δt₁ₐ and the removal of the rest of the thermoplastic polyester-based polymer (b-i) at the temperature T_{1b} is carried out for a period of time Δt_{1b}.

The sinterable non-organic particles (a) partly form sintering necks, so that the part is held together despite removal of the remaining binder components. Owing to the microporous structure of the part, thermal binder removal occurs quickly and uniformly.

Undesirable chemical reactions during the thermal binder removal may be avoided by means of an inert gas atmosphere or a reducing atmosphere or high vacuum. The inert gas atmosphere comprises, in particular, at least one noble gas which noble gas may suitably be selected from, e.g., nitrogen, helium and argon. The reducing atmosphere may include gases such as hydrogen, carbon dioxide, and/or carbon monoxide.

Suitably, sintering is carried out at a second temperature T₂ which is in the range of 600 to 2000° C., preferably 800 to 1800° C., more preferably 900 to 1500° C. In the production of a ceramic and/or vitreous part, the second temperature T₂ is preferably in the range of 600 to 2400° C., more preferably 800 to 2200° C., most preferably 1100 to 2000° C. In any case, the sintering temperature T₂ is below the melting temperature of the sinterable non-organic particles. The sintering at the second temperature T₂ is carried out for a period of time Δt₂ which is dependent on the geometry of the part and the material to be sintered. Preferably, the period of time Δt₂ is so long that no significant change in the porosity of the part can be achieved by subsequent further sintering. Sintering may be carried out at more than one temperature T₂, e.g. a sintering step at the temperature T₂ₐ is carried out for a period of time Δt₂a and another sintering step at the temperature T_{2b} is carried out for a period of time Δt_{2b}.

During this sintering step, the molded part will shrink essentially without affecting the shape of the molded part. The powder particles will fuse together and the open space between the powder particles disappears. Hence, during sintering, the density of the product increases and the product shrinks. The sintering step is commonly completed when the product has reached a density of about 90 to 100% by volume of the solid of which the powder is made, depending on the material and later use of the product.

Preferably, after the sintering step, the part is completely free of binder. As a result, the part forms an integral structure of high density.

The present invention is described in detail below with reference to the attached FIGURES and examples.

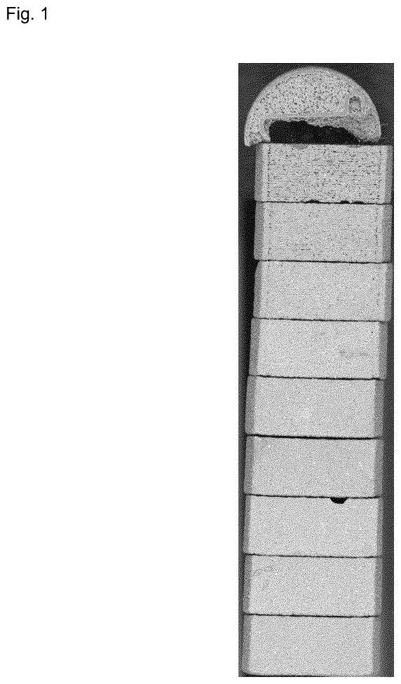

FIG. 1 depicts cylindrical testing specimen (green parts) produced with varying energy input by a laser additive manufacturing process.

### EXAMPLES

### Methods

### DSC Measurements

The DSC measurements were performed using a NETZSCH DSC 214 Polyma device. The sample was prepared in an aluminum Concavus pan (crucible) from NETZSCH with perforated lid. For this purpose, a sample is heated in a first heat ramp from −20° C. to 160° C., cooled to −20° C. afterwards and finally heated again in a second heat ramp from −20° C. to 160° C., each with a heating and cooling rate of 10 K/min. Measurement were performed with nitrogen in quality 5.0 as purging gas with a gas flow of 40 mL/min.

### Melt Index Flow Rate

The melt mass-flow rate, MFR, often also designated as melt index, describes the flow properties of plastics at a defined temperature. This property is measured by extruding a thermoplastic polymer melt through a capillary of known dimensions at a defined temperature and under a pressure determined by a weight. The result is the mass extruded per time unit, expressed in g/10 min. If the melt density is known, it is possible to determine the MFR from the melt volume flow rate, MVR. In this measurement procedure, the weighing of polymer sections is replaced by a continuous measurement of the extrusion volume. The result of the MVR value is expressed in cm³/10 min.

The experiments were performed on a Goettfert Melt Flow Index Tester according to DIN ISO 1133-1 with 2.16 kg at 190° C. Samples were dried for 6 hours at 80° C. before testing.

The following table 1 shows the properties of thermoplastic polyester-based polymers used in the examples that follow.

TABLE 1
DSC melt peak temperature T_{P}/T_{G}, melt volume flow rate MVR, and
melt viscosity values of components used as material (b i).

| | | crystalline / | T_{P} of (b-i) | MVR of (b-i) | |
|---|---|---|---|---|---|
| # | material (b-i) | amorphous | [°C] | [cm³/10 min] | conditions |
| 1 | Abifor 606 ^{[1]} | crystalline | 108-122 | 33.6 ^{[2]} | 2.16 kg, 160 °C |
| 2 | polycaprolactone ^{[3]} | crystalline | about 60 | — | — |
| 3 | Riteflex 425 ^{[4]} | crystalline | 155 | 13 | 2.16 kg, 190 °C |
| 4 | ENMAT Y1000P ^{[5]} | crystalline | 170-176 | 11.5 ^{[6]} | 2.16 kg, 190 °C |

^{[1]} polyester-based copolymer; data from product data sheet available from abifor adhesive technology
^{[2]} calculated from MFR 37 g/10 min assuming a density of 1.1 g/cm³
^{[3]} polycaprolactone available from Materialix
^{[4]} polyester-based thermoplastic elastomer; data from product data sheet available from Celanese GmbH
^{[5]} thermoplastic poly(hydroxybutyrat-co-hydroxyvalerat) resin; data from product data sheet available from TianAn Biologic Materials Co., Ltd.
^{[6]} calculated from MFR 14.4 g/10 min assuming a density of 1.25 g/cm³

### Production Examples

Binder components 1-B to 9-B were produced according to table 2.

TABLE 2
Binder components 1-B to 9-B; vol.-% relative
the total volume of the binder component (b).

| | | (b-i) | | (b-ii) |
|---|---|---|---|---|
| # | material (b-i) | [vol.-%] | material (b-ii) | [vol.-%] |
| 1-B | Abifor 606 ^{[1]} | 20 | Loxiol 2472 ^{[2]} | 78 |
| | | | Loxiol G20 ^{[3]} | 2 |
| 2-B | polycaprolactone ^{[4]} | 20 | Loxiol 2472 ^{[2]} | 60 |
| | | | Loxiol G20 ^{[3]} | 20 |
| 3-B | polycaprolactone ^{[4]} | 20 | monostearin ^{[5]} | 80 |
| 4-B | polycaprolactone ^{[4]} | 20 | N-ethyltoluene-4- | 75 |
| | | | sulfonamide ^{[6]} | |
| | | | Loxiol G20 ^{[3]} | 5 |
| 5-B | polycaprolactone ^{[4]} | 20 | Deurex A 27 P ^{[7]} | 77 |
| | | | Licocene 1332 TP ^{[8]} | 3 |
| 6-B | polycaprolactone ^{[4]} | 20 | 1-octadecanol ^{[9]} | 80 |
| 7-B | polycaprolactone ^{[4]} | 20 | diphenyl phthalate ^{[10]} | 75 |
| | | | Loxiol G20 ^{[3]} | 5 |
| 8-B | Riteflex 425 ^{[11]} | 20 | monostearin ^{[5]} | 80 |
| 9-B* | ENMAT | 20 | monostearin ^{[5]} | 80 |
| | Y1000P ^{[12]} | | | |
| 10-B* | ENMAT | 20 | Deurex A 27 P ^{[7]} | 77 |
| | Y1000P ^{[12]} | | Licocene 1332 TP ^{[8]} | 3 |

^{[1]} polyester-based copolymer available from abifor adhesive technology
^{[2]} 4-hydroxybenzoic behenylester available from Emery Oleochemicals GmbH
^{[3]} stearic acid available from Emery Oleochemicals GmbH
^{[4]} polycaprolactone available from Materialix
^{[5]} monostearin (glycerol 2-stearate) available TCI Deutschland GmbH
^{[6]} N-ethyltoluene-4-sulfonamide available from Sigma-Aldrich
^{[7]} oleamide available from Deurex AG
^{[8]} propylene-ethylene-maleic anhydride copolymer available from Clariant International Ltd
^{[9]} 1-octadecanol available from Sigma-Aldrich
^{[10]} diphenyl phthalate available from Sigma-Aldrich
^{[11]} polyester-based thermoplastic elastomer available from Celanese GmbH
^{[12]} thermoplastic poly(hydroxybutyrat-co-hydroxyvalerat) resin from TianAn Biologic Materials Co., Ltd.
*comparative example.

Feedstock compound 1-F of binder component 1-B was produced according to table 3.

TABLE 3
Feedstock compound 1-F and 2-F (vol.-% relative the
total volume of the particulate feedstock compound).

| | | amount (a) | binder comp. (b) | amount (b) |
|---|---|---|---|---|
| # | metal (a) | [vol.-%] | (# in table 2) | [vol.-%] |
| 1-F | stainless steel 316 L ^{[1]} | 65 | 1-B | 35 |
| 2-F | stainless steel 316 L ^{[1]} | 65 | 9-B | 35 |

^{[1]} gas atomized, particle size 90%: 22 μm, available from Sandvik Osprey Ltd.
* comparative example.

### Manufacture of Green Parts

### Laser Additive Manufacturing

Cylindrical testing specimen were produced by a laser additive manufacturing process using a Formiga P110 (available from EOS GmbH) with varying energy input, see table 4. The feedstock compound 1-F of table 3 was used as starting material. The powder bed surface temperature was 50° C.

TABLE 4
Process conditions for the production
of cylindrical testing specimen.

| | hatch | laser | laser | energy | |
|---|---|---|---|---|---|
| | spacing | output | speed | input | density ^{[1]} |
| # | [mm] | [W] | [mm/s] | [mJ/mm²] | [g/cm³] |
| 1 | 0.13 | 7 | 3000 | 17.9 | 4.728 |
| 2 | 0.13 | 9 | 3000 | 23.1 | 5.065 |
| 3 | 0.13 | 11 | 3000 | 28.2 | 5.269 |
| 4 | 0.13 | 13 | 3000 | 33.3 | 5.394 |
| 5 | 0.13 | 15 | 3000 | 38.5 | 5.450 |
| 6 | 0.13 | 17 | 3000 | 43.6 | 5.466 |
| 7 | 0.13 | 19 | 3000 | 48.7 | 5.477 |
| 8 | 0.13 | 21 | 3000 | 53.8 | 5.484 |
| 9 | 0.13 | 23 | 3000 | 59.0 | 5.502 |
| 10 | 0.13 | 25 | 3000 | 64.1 | 5.519 |

^{[1]} Archimedes density

The resulting cylindrical testing specimen (green parts) #1 through #10 are depicted in FIG. 1 from top to bottom.

As can be seen from the data of table 4 and FIG. 1, cylindrical testing specimen having adequate densities and high dimensional printing accuracy were obtained at a laser output at 13 W or more, superior densities and high dimensional printing accuracy were obtained at a laser output at 23 W or more.

Processing the comparative feedstock compound 2-F resulted in green parts having blurred edges and faces, and in insufficient green part densities.

### Manufacture of Sintered Specimens

Test specimen were additively manufactured using feedstock compound 1-F according to table 3 with a Formiga P110 as described above obtaining a green part of the test specimen. Said green part was then subjected to a solvent debinding step and a sintering step. For solvent debinding, the green part of feedstock compound 1-F was dipped into ethanol at a temperature of 25° C. for 16 h. Sintering was carried out in a cycle with a heating and cooling rate of 5 K/min, holding times of 2 h at 380° C., of 1 h at 600° C., of 30 min at 1100° C. and of 2 h at a final sintering temperature of 1380° C.

1. (canceled)

2. The process of claim 14, wherein, if T_{P} is present, T_{P} is 150° C. or lower,
or, if T_{P} is absent, T_{G} is 150° C. or lower.

3. The process of claim 14, wherein the thermoplastic polyester-based polymer has a melt volume-flow rate of at least 1 cm³/10 min, according to ISO 1133 with 2.16 kg at 160° C.

4. (canceled)

5. The process of claim 14, wherein the wax or wax-type material is selected from aromatic esters and aromatic sulfonamides.

6. The process of claim 14, wherein the binder component additionally comprises a plasticizer.

7. The process of claim 14, wherein the binder component additionally comprises a dispersant.

8. The process of claim 7, wherein the dispersant is selected from fatty acids having 10 to 24 carbon atoms.

9. The process of claim 14, wherein b-i) and b-ii) constitute at least 70% by volume of the binder component.

10. The process of claim 14, wherein the sinterable non-organic particles (a) are selected from metals, alloys, vitreous particles and ceramic particles.

11. The process of claim 14, containing the sinterable non-organic particles (a) in an amount of about 0.70 to 0.99·φᵣ by volume, wherein φᵣ is the critical solids loading by volume.

12. The process of claim 14, wherein the amount of
the sinterable non-organic particles a) is in the range of about 20 to 90% by volume, and
the amount of the binder component b) is in the range of about 10 to 80% by volume.

13. The process of claim 14, wherein the feedstock compound particles have a particle size distribution such that at least 80% by volume of the particulate feedstock compound has a maximum particle size Bₘₐₓ in the range of 0.005 to 0.3 mm.

14. A process comprising:
(1) merging a plurality of feedstock compound particles to obtain a green part,
wherein the step of merging comprises the steps of:
providing a first layer of feedstock compound particles;
selectively densifying the first layer of feedstock compound particles to bind the compound particles to each other in a predefined manner so to produce a first shaped part layer;
providing at least one further layer of feedstock compound particles on the first shaped part layer; and
selectively densifying the further layer feedstock compound particles to bind the feedstock compound particles to each other in a predefined manner so to produce at least one further shaped part layer, the first shaped part layer and the further shaped part layers forming a green part wherein the feedstock compound particles comprise,
a) sinterable non-organic particles having a maximum particle size of 200 μm dispersed throughout the compound particle, and
b) a binder component, the binder component comprising, relative to the volume of the binder component
b-i) 3 to 70% by volume of a thermoplastic polyester-based polymer, and
b-ii) 30 to 97% by volume of a wax or wax-type material having a drop point in the range of 20 to 160° C., wherein the wax or wax-type material is selected from polar waxes and polar wax-type materials,
wherein b-i) and b-ii) constitute at least 60% by volume of the binder component,
wherein the polyester-based polymer has at least one of a glass transition temperature T_{G} and a crystalline melting temperature T_{P}, and,
if T_{P} is present, T_{P} is 160° C. or lower, or,
if T_{P} is absent, T_{G} is 160° C. or lower.

15. (canceled)

16. (canceled)

17. The process of claim 14, wherein selectively densifying the first and further layer of compound particles involves selectively irradiating at least one of the first or the at least one further layer with electromagnetic radiation.

18. The process of claim 14 further comprising the steps of:
(2) partially debinding the green part by selectively removing the wax or wax-type material b-ii) to obtain a brown part comprising the sinterable non-organic particles a) bound to each other by the thermoplastic polyester-based polymer b-i), and
(3) sintering the brown part to obtain a sintered part.
